(19) United States
(12) Patent Application Publication
(10) Pub. No.: US 2022/0360592 A1
(43) Pub. Date: Nov. 10, 2022

(54) SYSTEMS AND METHODS OF MONITORING AND DETECTING SUSPICIOUS ACTIVITY IN A VIRTUAL ENVIRONMENT

(71) Applicants: Bradley Stuart Grantham, Holly Springs, NC (US); Brian Marc Ferro, Apex, NC (US); Lukayn Thomas Hunsicker, Miami Beach, FL (US)

(72) Inventors: Bradley Stuart Grantham, Holly Springs, NC (US); Brian Marc Ferro, Apex, NC (US); Lukayn Thomas Hunsicker, Miami Beach, FL (US)

(21) Appl. No.: 17/738,857

(22) Filed: May 6, 2022

Related U.S. Application Data
(60) Provisional application No. 63/185,217, filed on May 6, 2021.

(51) Int. Cl. H04L 9/40

(52) U.S. Cl. CPC H04L 63/1408

(57) ABSTRACT

Systems and methods of monitoring and detecting suspicious activity in a virtual environment are provided. In one exemplary embodiment, a method performed by a first network node of monitoring and detecting suspicious activity in a virtual environment comprises sending, to a second network node that operates a virtual environment, an indication that user activity performed in the virtual environment that is associated with a certain user profile of a plurality of user profiles of the virtual environment is suspicious activity. Further, the user activity performed in the virtual environment that is associated with the certain user profile is enabled by a third network node. In addition, the suspicious activity is determined based on a relationship between the user activity performed in the virtual environment that is associated with the certain user profile and other user profiles, or an attribute of the certain user profile or the third network node.

### CROSS REFERENCE TO RELATED APPLICATIONS

This application claims the benefit of U.S. Prov. App. No. 63/185,217, filed May 6, 2021, which is hereby incorporated by reference as if fully set forth herein.

### FIELD OF DISCLOSURE

The present disclosure relates generally to the field of monitoring virtual environments, and in particular to monitoring and detecting suspicious activity in a virtual environment.

### BACKGROUND

The video gaming industry has come a long way since Atari, Inc. released Pong in 1972. The gaming landscape has evolved since then, branching out from arcades where people lined up to pump hundreds of quarters into the refrigerator-sized machines, to now shoebox-sized home systems where countless hours are spent on old and new classics. As the home systems have grown in popularity, they have also pushed advances in the technologies to keep people engaged—from special effects that rival blockbuster movies to battling opponents half a world away via online play as well as the adoption of virtual assets to help players gain an advantage over other players.

To say that the gaming industry, particularly the online community, is massive, would be a understatement. There are currently over two billion e-gamers globally, generating approximately $140 billion per year for gaming industry, dwarfing the revenue generated by Hollywood whose ticket receipts totaled about $43 billion in 2019. And there are no signs of the popularity and spend slowing, with the market predicted to reach $300 billion by 2025. A large portion of this spend is derived from online purchases that players make when playing online games such as when they buy in-game currency or an in-game item (e.g., virtual asset).

While the gaming industry has traditionally generated revenue from selling consoles and games in retail stores, the model changed with personal Wi-Fi becoming a commodity that has led to the popularity of online gaming. This business model has now shifted to provide in-game content, ranging from additional levels, customizable characters, special weapons and even as simple as tokens instead of in-store purchases. This all leads to game developers that are now also operating online marketplaces where players can purchase assets and buy or sell these assets later in addition to working on creating the next best game. And while this might seem like a natural progression for expanding business ventures, it's also pushing game developers into a possible un-intended space of becoming virtual asset service providers (VASP), which some also view as synonymous with cryptocurrency exchanges.

As regulators are increasing their attention to the expanding cryptocurrency arena, mainly those conducting transactions with Bitcoin, Litecoin and more common digital assets, criminals are looking to exploit vulnerable sectors as creative methods to launder proceeds of crime. Also known as a displacement effect—where one part of the financial system becomes more tightly regulated, illicit funds start to funnel elsewhere—the online gaming community is now starting to experience this effect.

In fact, the developers of a popular online game which provides the ability to purchase a variety of gaming content or virtual assets, had recently announced that players were restricted from trading or selling certain virtual assets with other gamers. This restriction was directly related to the game becoming a known target for money laundering by organized crime rings. Criminals had been found to purchase virtual assets with their criminal proceeds, sell these assets to other users and receive funds from legitimate sources in order to ‘clean’ the funds.

While legislation has been catching up with technology—virtual currencies, exchange providers and digital wallets all now falling under some sort of regulatory guidance—online gaming appears to be following as the next domain to fall under regulatory scrutiny.

Given the potential for large sums of money to be laundered through online gaming platforms, the Financial Action Task Force (FATF) has published recommendations that virtual assets and VASPs be brought within AML regulations. The FATF defines a virtual asset as “a digital representation of value that can be digitally traded or transferred and can be used for payment or investment purposes.” Although in-game content might not have intrinsic value, it is still seen as valuable by many. As the prices of cryptocurrencies demonstrate, a virtual currency can acquire significant economic value in the eyes of the public. Given that in-game content can be traded in an open and competitive market, there is a strong argument that it meets the FATF's virtual asset definition. This in turn could subject them to supervision by the relevant regulators. This would include being required to take steps to monitor suspicious and higher-risk transactions and customers.

Game developers should already be looking to put measures in place to address the risks of money laundering to become standard practice for the gaming industry. These measures can help to protect developers from the reputational risk of becoming a tool for organized crime and prepare for potential increasing scrutiny that is already being applied to banks or other financial institutions.

There appear to be several areas where developers can be proactive, including implementing a customer due diligence policy, understanding the anti-money laundering measures of their payment processors, monitoring of transactions for suspicious activity, and voluntary reporting of suspicious activity

Accordingly, there is a need for improved techniques for monitoring and detecting suspicious activity in a virtual environment. In addition, other desirable features and characteristics of the present disclosure will become apparent from the subsequent detailed description and embodiments, taken in conjunction with the accompanying figures and the foregoing technical field and background.

The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

Briefly described, embodiment of the present disclosure relate to systems and methods monitoring and detecting suspicious activity in a virtual environment. According to one aspect, a method performed by a first network node of monitoring and detecting suspicious activity in a virtual environment comprises sending, by the first network node, to a second network node that operates a virtual environment, an indication that user activity performed in the virtual environment that is associated with a certain user profile of a plurality of user profiles of the virtual environment is suspicious activity. Further, this user activity is enabled by a third network node. In addition, the suspicious activity is determined based on: a relationship between the user activity performed in the virtual environment that is associated with the certain user profile and user activity performed in the virtual environment that is associated with another user profile of the plurality of user profiles; an attribute of the certain user profile; or an attribute of the third network node.

According to another aspect, the method further includes determining a suspicious activity risk score or level based on a suspicious activity risk classification rule set and the attribute of the certain user profile.

According to another aspect, the risk classification rule set includes at least one of: an indication of whether the user is associated with a certain watchlist; an indication of whether the user is associated with a certain group; and an indication of whether the user is associated with certain legal or law enforcement activity.

According to another aspect, the method further includes determining a suspicious activity detection rule set based on the risk score or level.

According to another aspect, the method further includes estimating, based on the detection rule set, the relationship between the user activity associated with the certain user profile and the user activity associated with the other user profile.

According to another aspect, the step of estimating further includes regression analysis modeling, based on the detection rule set, the relationship between the user activity associated with the certain user profile and the user activity associated with the other user profile.

According to another aspect, the method further includes determining that the user activity associated with the certain user profile is suspicious activity based on the estimated relationship and the attribute associated with the third network node.

According to another aspect, the method further includes determining that the user activity associated with the certain user profile is suspicious activity based on the attribute of the third network node responsive to determining that the estimated relationship is outside a predetermined activity threshold.

According to another aspect, the method further includes receiving, by the first network node, from the second network node, the user activity associated with the certain user profile.

According to another aspect, the method further includes receiving, by the first network node, from the second network node, the attribute of the certain user profile or the attribute of the third network node.

According to another aspect, the attribute of the third network node includes at least one of an operating system (OS), screen pixelization, X/Y axis movement, and Internet protocol (IP) address.

According to another aspect, the attribute associated with the certain user profile includes at least one of an occupation, citizenship, and residency of the certain user.

According to another aspect, the detection rule set is associated with regulatory policies.

According to one aspect, a first network node comprises a processor and a memory, with the memory containing instructions executable by the processor whereby the processor is configured to send, to a second network node that operates a virtual environment, an indication that user activity performed in the virtual environment that is associated with a certain user profile of a plurality of user profiles of the virtual environment is suspicious activity. Further, this user activity is enabled by a third network node. In addition, the suspicious activity is determined based on: a relationship between the user activity performed in the virtual environment that is associated with the certain user profile and user activity performed in the virtual environment that is associated with another user profile of the plurality of user profiles; an attribute of the certain user profile; or an attribute of the third network node.

According to one aspect, a method performed by a second network node of monitoring and detecting suspicious activity in a virtual environment comprises receiving, by the second network node that operates a virtual environment, from a first network node, an indication that user activity performed in the virtual environment associated with a certain user profile of a plurality of user profiles of the virtual environment is suspicious activity. Further, this user activity is enabled by a third network node. In addition, the suspicious activity is determined based on: a relationship between the user activity performed in the virtual environment associated with the certain user profile and user activity performed in the virtual environment associated with another user profile of the plurality of user profiles; an attribute of the certain user profile; or an attribute of the third network node.

According to one aspect, a second network node comprises a processor and a memory, with the memory containing instructions executable by the processor whereby the processor is configured to receive, by the second network node that operates a virtual environment, from a first network node, an indication that user activity associated with a certain user profile of a plurality of user profiles of the virtual environment is suspicious activity, with that user activity being enabled by a third network node, the suspicious activity being determined based on: a relationship between the user activity performed in the virtual environment associated with the certain user profile and user activity performed in the virtual environment associated with another user profile of the plurality of user profiles; an attribute of the certain user profile; or an attribute of the third network node.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system of monitoring and detecting suspicious activity in a virtual environment in accordance with various aspects as described herein.

FIG. 2 illustrates one embodiment of a first network node in accordance with various aspects as described herein.

FIGS. 3A-B illustrate other embodiments of a first network node in accordance with various aspects as described herein.

FIG. 4 illustrates one embodiment of a method performed by a first network node of monitoring and detecting suspicious activity in a virtual environment in accordance with various aspects as described herein.

FIG. 5 illustrates another embodiment of a network node in accordance with various aspects as described herein.

FIG. 6 illustrates one embodiment of a second network node in accordance with various aspects as described herein.

FIGS. 7A-B illustrate other embodiments of a second network node in accordance with various aspects as described herein.

FIG. 8 illustrates one embodiment of a method performed by a second network node of monitoring and detecting suspicious activity in a virtual environment in accordance with various aspects as described herein.

FIGS. 9A-C illustrate other embodiments of a method performed by a first network node of monitoring and detecting suspicious activity in a virtual environment in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

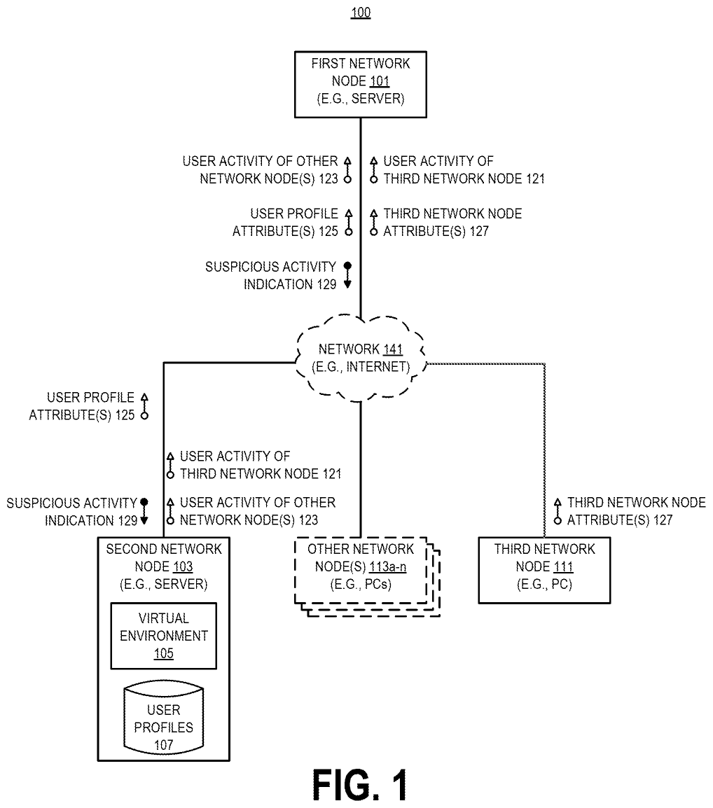

In this disclosure, systems and methods of monitoring and detecting suspicious activity in a virtual environment are provided. In one example, FIG. 1 illustrates one embodiment of a system 100 of monitoring and detecting suspicious activity in a virtual environment in accordance with various aspects as described herein. In FIG. 1, the system 100 includes a first network node 101 (e.g., server) communicatively coupled to a second network node 103 (e.g., server) via network 141 (e.g., Internet). Further, the first and second network nodes 101, 103 are communicatively coupled to a third network node 111 (e.g., PC) via the network 141. In addition, other network nodes 113a-n (e.g., PCs) are communicatively coupled to at least the first network node 101 via the network node 141. The second network node 103 is configured to operate a virtual environment 105 (e.g., gaming platform, social media web site) that allows users to access the virtual environment 105 from the third network node 111 and the other network nodes 113a-n.

In FIG. 1, in operation, the first network node 101 may receive from the second network node 103 user activity 121 performed in the virtual environment 105 and associated with a certain user profile of a plurality of user profiles 107. Further, the user activity 121 is enabled by the third network node 111. Further, the first network node 101 may receive from the second network node 103 an attribute 125 of the certain user profile or an attribute 127 of the third network node 111. The attribute 125 of the certain user profile can include an occupation, a citizenship, a residency, or the like of a user. The attribute 127 of the third network node 111 can include an operating system (OS), a screen pixelization, an X/Y axis movement, an Internet protocol (IP) address, or the like of the third network node 111.

In the current embodiment, the first network node 101 may determine a suspicious activity risk score or level based on a suspicious activity risk classification rule set and the attribute 125 of the current user profile. Further, the first network node 101 may determine a suspicious activity detection rule set based on the risk score or level. The first network node 101 may also estimate, based on the suspicious activity detection rule set, the relationship between the user activity performed in the virtual environment 105 that is associated with the certain user profile and user activity performed in the virtual environment 105 that is associated with the other user profiles 107. The first network node 101 may then determine that the estimated relationship is outside a predetermined normal activity threshold. In addition, the first network node 101 may determine that the user activity performed in the virtual environment 105 associated with the certain user profile is suspicious activity based on the attribute 127 of the third network node 111 responsive to determining that the estimated relationship is outside a predetermined normal activity range or threshold. In response to detecting suspicious activity, the first network node 101 sends to the second network node 103 an indication 129 that the certain user activity is suspicious activity based on the estimated relationship, the attribute 125 of the certain user profile, or the attribute 127 of the third network node 111.

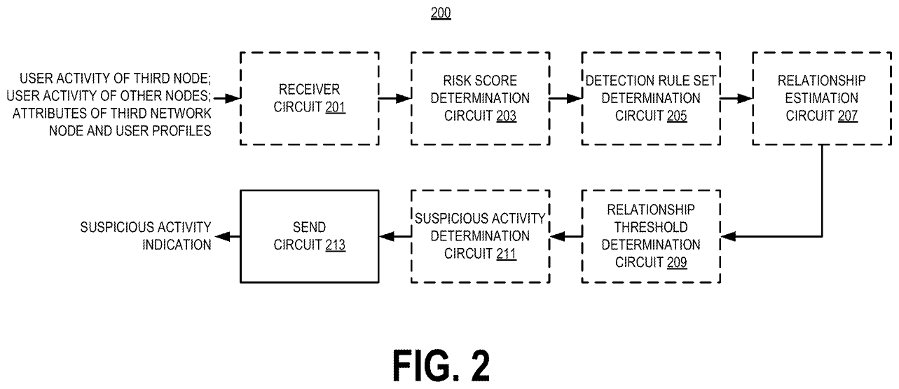

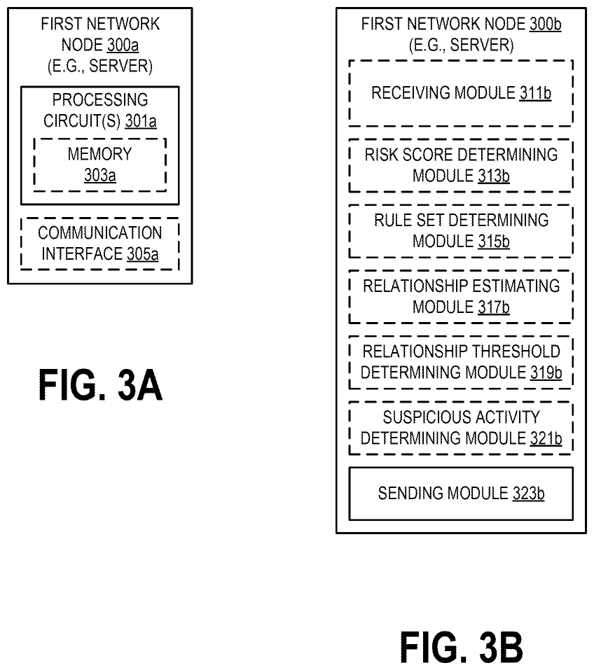

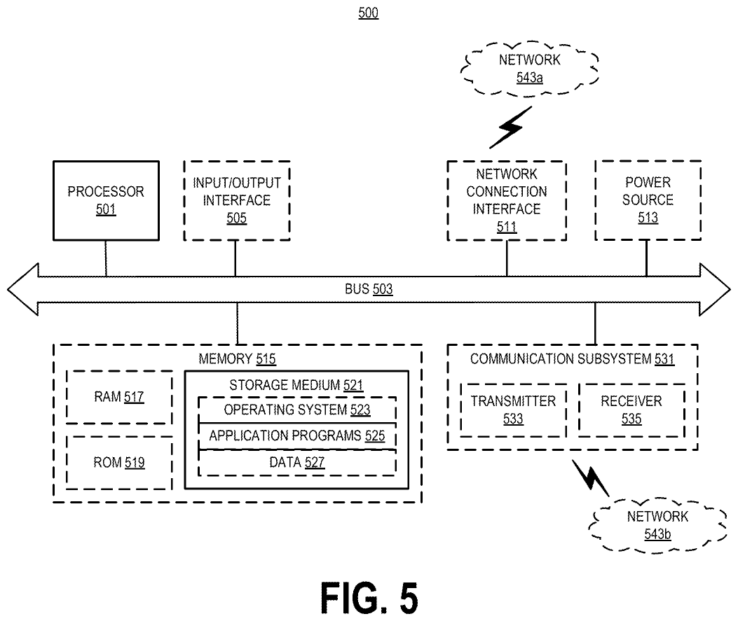

FIG. 2 illustrates one embodiment of a first network node 200 in accordance with various aspects as described herein. In FIG. 2, the node 200 implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) herein) may include for instance: a receiver circuit 201 configured to receive information; a risk score determination circuit 203 configured to determine a suspicious activity risk score or level based on a suspicious activity risk classification rule set and an attribute of a certain user profile; a detection rule set determination circuit 205 configured to determine a suspicious activity detection rule set based on the risk score or level; a relationship estimation circuit 207 configured to estimate, based on the detection rule set, the relationship between the user activity performed in the virtual environment that is associated with the certain user profile and user activity performed in the virtual environment that is associated with other user profiles; a relationship threshold determination circuit 209 configured to determine that the estimated relationship is outside a predetermined normal activity threshold; a suspicious activity determination circuit 211 configured to determine that the user activity is suspicious activity based on the attribute of the third network node; and a send circuit 213 configured to send information.

FIGS. 3A-B illustrate other embodiments of a first network node 300a-b in accordance with various aspects as described herein. In FIG. 3A, the node 300a may include processing circuitry 301a that is operably coupled to memory 303a, communications circuitry 305a, the like, or any combination thereof. The communication circuitry 305a is configured to transmit and/or receive information to and/or from one or more other nodes via any communication technology. The processing circuitry 301a is configured to perform processing described herein, such as by executing instructions stored in memory 303a. The processing circuitry 303a in this regard may implement certain functional means, units, or modules.

In FIG. 3B, the node 300b implements various functional means, units, or modules (e.g., via the processing circuitry 301a in FIG. 3A, via the processing circuitry 501 in FIG. 5, via software code, or the like). In one embodiment, these functional means, units, or modules (e.g., for implementing the method(s) described herein) may include for instance: a receiving module 311b for receiving information; a risk score determining module 313b for determining a suspicious activity risk score or level based on a suspicious activity risk classification rule set and an attribute of a certain user profile; a detection rule set determining module 315b for determining a suspicious activity detection rule set based on the risk score or level; a relationship estimating module 317b for estimating, based on the detection rule set, the relationship between the user activity performed in the virtual environment that is associated with the certain user profile and user activity performed in the virtual environment that is associated with other user profiles; a relationship threshold determining module 319b for determining whether the estimated relationship is outside a predetermined normal activity threshold; a suspicious activity determining module 321b for determining that the user activity is suspicious activity based on the attribute associated with the third network node; and a sending module 323b for sending information.

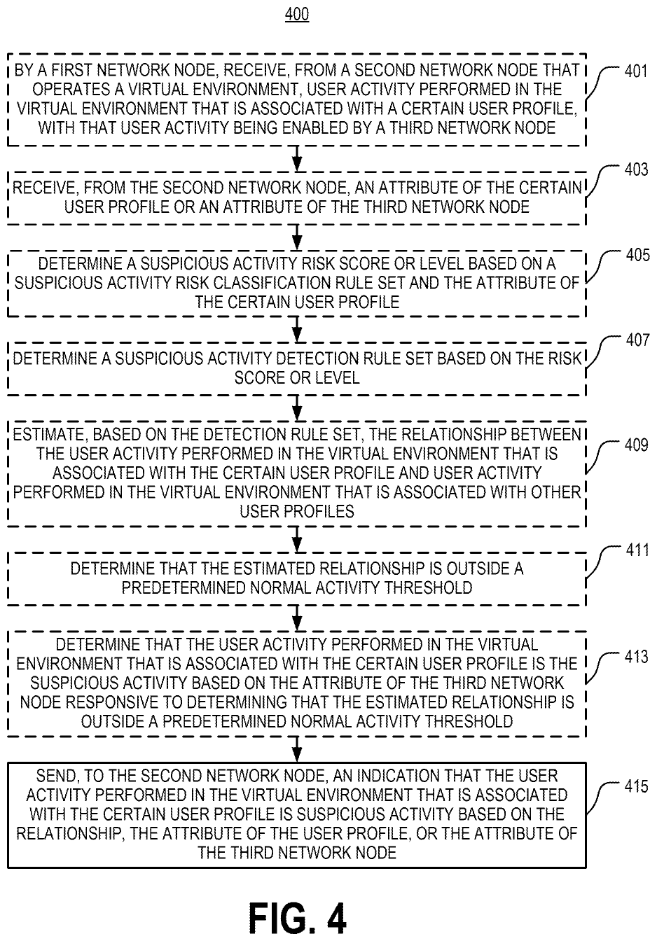

FIG. 4 illustrates one embodiment of a method 400 performed by a first network node of monitoring and detecting suspicious activity in a virtual environment in accordance with various aspects as described herein. In FIG. 4, the method 400 may start, for instance, at block 401 where it may include receiving, from a second network node that operates a virtual environment, user activity performed in the virtual environment that is associated with a certain user profile. At block 403, the method 400 may also include receiving, from the second network node, an attribute of the certain user profile or an attribute of the third network node. At block 405, the method 400 may include determining a suspicious activity risk score or level based on a suspicious activity risk classification rule set and the attribute of the certain user profile. At block 407, the method 400 may include determining a suspicious activity detection rule set based on the risk score or level. At block 409, the method 400 may include estimating, based on the detection rule set, the relationship between the user activity performed in the virtual environment that is associated with the certain user profile and user activity performed in the virtual environment that is associated with other user profiles. At block 411, the method 400 may include determining whether the estimated relationship is outside a predetermined normal activity threshold. At block 413, the method 400 may include determining whether the user activity performed in the virtual environment that is associated with the certain user profile is the suspicious activity based on the attribute of the third network node responsive to determining that the estimated relationship is outside a predetermined normal activity threshold. At block 415, the method includes sending, to the second network node, an indication that the user activity performed in the virtual environment that is associated with the certain user profile is suspicious activity based on the relationship, the attribute of the user profile, or the attribute of the third network node.

FIG. 5 illustrates another embodiment of a network node 500 in accordance with various aspects as described herein. In FIG. 5, network node 500 includes processing circuitry 501 that is operatively coupled to input/output interface 505, network connection interface 511, memory 515 including random access memory (RAM) 517, read-only memory (ROM) 519, and storage medium 521 or the like, communication subsystem 531, power source 513, and/or any other component, or any combination thereof. Storage medium 521 includes operating system 523, application program 525, and data 527. In other embodiments, storage medium 521 may include other similar types of information. Certain network nodes may utilize all of the components shown in FIG. 5, or only a subset of the components. The level of integration between the components may vary from one network node to another network node. Further, certain network nodes may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. The network node 500 may be configured to use an output device via input/output interface 505. An output device may use the same type of interface port as an input device. For example, a USB port may be used to provide input to and output from the network node 500. The output device may be a speaker, a sound card, a video card, a display, a monitor, a printer, an actuator, an emitter, a smartcard, another output device, or any combination thereof. The network node 500 may be configured to use an input device via input/output interface 505 to allow a user to capture information into the network node 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, an infrared sensor, a proximity sensor, another like sensor, or any combination thereof. For example, the input device may be an optical sensor and an infrared sensor.

In FIG. 5, network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as a retail item selection program, a widget or gadget engine or another application, and a data file 527. The storage medium 521 may store, for use by the network node 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the network node 500 to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

In FIG. 5, the processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another network node capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the network node 500.

The features, benefits and/or functions described herein may be implemented in one of the components of the network node 500 or partitioned across multiple components of the network node 500. Further, the features, benefits, and/or functions described herein may be implemented in any combination of hardware, software or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

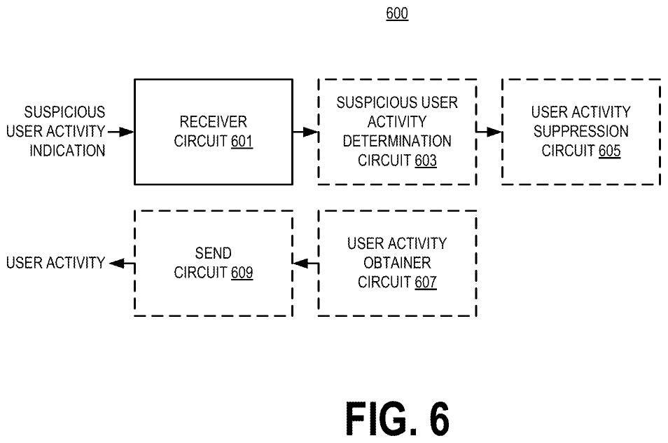

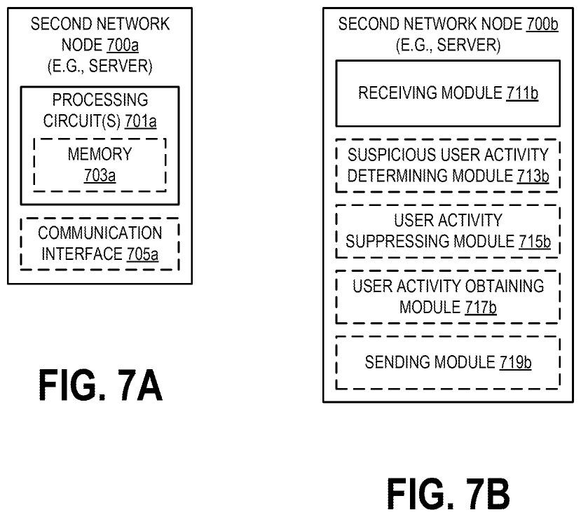

FIG. 6 illustrates one embodiment of a second network node 600 in accordance with various aspects as described herein. In FIG. 6, the node 600 implements various functional means, units, or modules (e.g., via the processing circuitry 701a in FIG. 7A, via the processing circuitry 501 in FIG. 5, via software code, or the like), or circuits. In one embodiment, these functional means, units, modules, or circuits (e.g., for implementing the method(s) herein) may include for instance: a receiver circuit 601 configured to receive information; a suspicious user activity determination circuit 603 configured to determine that user activity performed in a virtual environment that is associated with a certain user profile of the virtual environment is suspicious activity; a user activity suppression circuit 605 configured to suppress the user activity performed in the virtual environment that is associated with the certain user profile; a user activity obtainer circuit 607 configured to obtain the user activity performed in the virtual environment that is associated with the certain user profile; and a send circuit 609 configured to send information.

FIGS. 7A-B illustrate other embodiments of a second network node 700a-b in accordance with various aspects as described herein. In FIG. 7A, the node 700a may include processing circuitry 701a that is operably coupled to memory 703a, communications circuitry 705a, the like, or any combination thereof. The communication circuitry 705a is configured to transmit and/or receive information to and/or from one or more other nodes via any communication technology. The processing circuitry 701a is configured to perform processing described herein, such as by executing instructions stored in memory 703a. The processing circuitry 703a in this regard may implement certain functional means, units, or modules.

In FIG. 7B, the node 700b implements various functional means, units, or modules (e.g., via the processing circuitry 701a in FIG. 7A, via the processing circuitry 501 in FIG. 5, via software code, or the like). In one embodiment, these functional means, units, or modules (e.g., for implementing the method(s) described herein) may include for instance: a receiving module 711b for receiving information; a suspicious user activity determining module 713b for determining that user activity performed in a virtual environment that is associated with a certain user profile of the virtual environment is suspicious activity; a user activity suppressing module 715b for suppressing the user activity performed in the virtual environment that is associated with the certain user profile; a user activity obtaining module 717b for obtaining the user activity performed in the virtual environment that is associated with the certain user profile; and a sending module 719b for sending information.

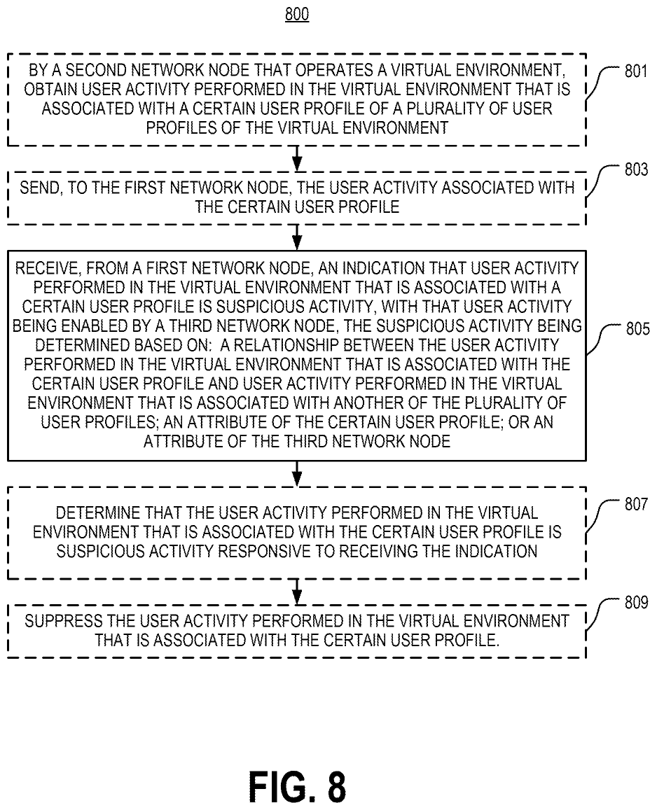

FIG. 8 illustrates one embodiment of a method 800 performed by a second network node of monitoring and detecting suspicious activity in a virtual environment in accordance with various aspects as described herein. In FIG. 8, the method 800 may start, for instance, at block 801 where it may include obtaining user activity performed in the virtual environment that is associated with a certain user profile of a plurality of user profiles of the virtual environment. At block 803, the method 800 may include sending, to the first network node, the user activity associated with the certain user profile. At block 805, the method 800 includes receiving, from a first network node, an indication that user activity performed in the virtual environment that is associated with a certain user profile is suspicious activity, with the suspicious activity being determined based on: a relationship between the user activity performed in the virtual environment that is associated with the certain user profile and user activity performed in the virtual environment that is associated with another of the plurality of user profiles; an attribute of the certain user profile; or an attribute of the third network node. At block 807, the method 800 may include determining that the user activity performed in the virtual environment that is associated with the certain user profile is suspicious activity responsive to receiving the indication. At block 809, the method 800 may include suppressing the user activity performed in the virtual environment that is associated with the certain user profile. A skilled artisan will readily recognize techniques for suppressing user activity performed in a virtual environment.

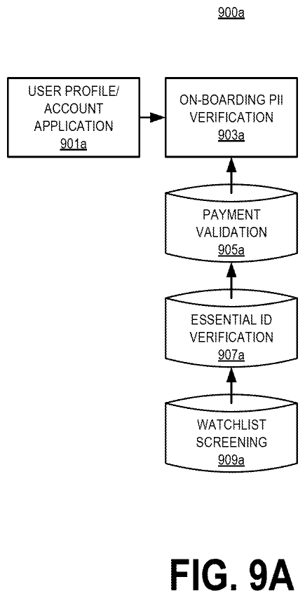

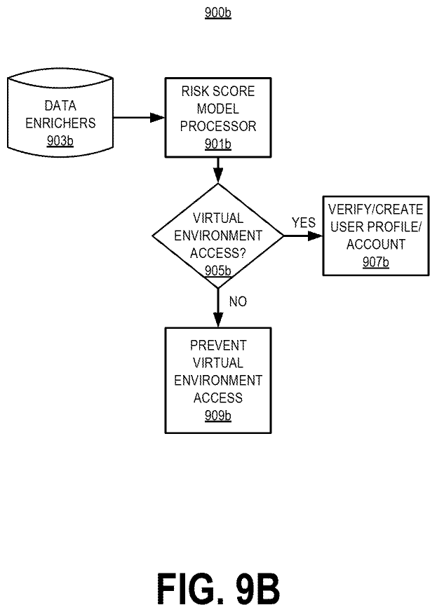

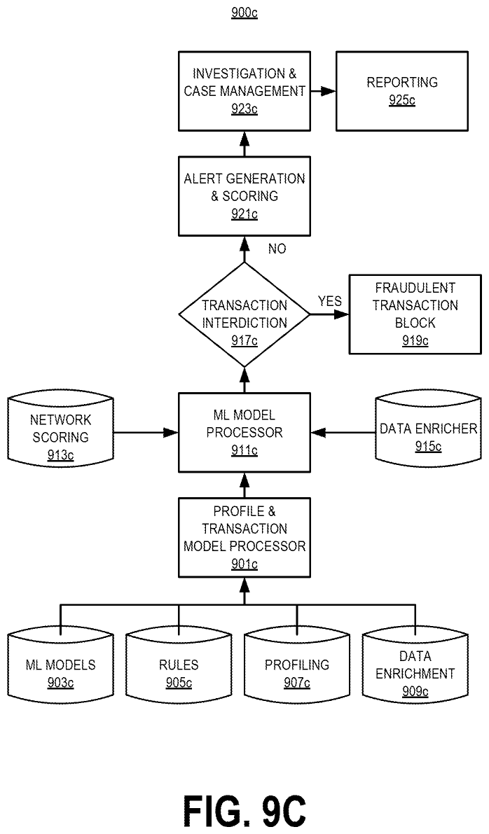

FIGS. 9A-C illustrate other embodiments of a method 900a-e performed by a first network node of monitoring and detecting suspicious activity in a virtual environment in accordance with various aspects as described herein. In FIG. 9A, the method 900a includes authenticating and validating a user profile/account, with the system entry point represented by block 901a. Further, pending, new and existing user profiles/accounts are screened for personally identifiable information (PII) such as an email address or user tag, as represented by block 903a. Any payment information may be verified with a payment processor, including screening against any provided PII information and existing negative user profile/account lists, as represented by block 905a. In addition, identification verification of a user profile/account may need to be performed such as to verify the age associated with the user profile/account to allow access to mature subject matter or to verify the user profile/account against a customer identification program (CIP) for U.S. anti-money laundering, as represented by block 907a. The user profile/account may require screening against a standardized Office of Foreign Assets Control (OFAC) watchlist or other similar watchlists, as represented by block 909a.

In FIG. 9B, after the user profile/account is authenticated and validated, the user profile/account is processed by a risk score model processor to obtain a risk score or level (e.g., risk score between 0 and 1,000), as represented by block 901b. The risk score model processor can apply standard risk rules for attributes associated with the user to generate a risk score for the user profile/account. Further, these attributes may be enriched using third party data, as represented by block 903b. The risk score model processor can apply workflows and threshold tuning to segment user profiles/accounts into risk levels such as high, medium and low risk. The risk score or level is evaluated to determine whether the corresponding user profile/account can have access to the virtual environment, as represented by block 905b. A user profile/account can be verified, opened or created if the risk score or level is approved, as represented by block 907b. Otherwise, the user profile/account is prevented from having access to the virtual environment, as represented by block 909b.

Once the user has been onboarded, the users aggregate activity will be profiled as monitored by policy rule set. Regression analysis modeling (e.g., gradient trees, random forests) will be deployed across the rule set to monitor for activity exceeding normal banded behavior. When a risk threshold is triggered, specific data enrichments (e.g., CPU OS, screen pixelization, IP address, X/Y-axis movement, geography) will be utilized to determine whether generated alert is a false positive or true positive. In addition, in the event of account take over or artifact theft, the same data enrichers can be utilized to notify gaming communities, law enforcement and/or online stores or auction sites (e.g., eBay, Craigslist or Amazon) on the impacted account or gaming artifact, preventing the monetization of stolen digital goods.

Regulatory policy can establish the baseline rule set, allowing for user classifications. The risk score can be generated from digital user attributes gathered from the applicants as well as outside data enrichers. Aggregated scores can then be weighted and used to bucket users in Low/Med/High or exiting application. One example of a regulatory policy that can drive rules is: Does the user appear on a global sanctions watchlist? Watchlists can be provided from outside data enrichers. If found on a list, immediately exit application. If not found, proceed. Another example of a regulatory policy that can drive rules is: Is this entity a politically exposed person (PEP) or a related/close associate (RCA)? Like watchlists, does the entity appear to be a PEP or an RCA? If yes, entity immediately becomes high risk, necessitating more close review of activity and behavior (feeds into detection rules). Another example of a regulatory policy that can drive rules is: Is there negative/adverse media for this entity? If open source media indicates entity to be connected to pending legal or law enforcement activity, raise risk level of user for increased scrutiny for detection rules. Another example of a regulatory policy that can drive rules is: What is the occupation or address of residency for the entity? Use of user attributes (e.g., occupation, citizenship, residency) with each of these attributes falling into a scalable risk threshold that increases weight based on risk. For example, addresses in China might be considered higher risk than those of Norway. These scores are then aggregated and combined for an overall risk score. This score will then fall into a low/medium/high risk band or level. The user risk score in turn is used for the detection rules. Low risk users are reviewed, but to a lower extent than a high risk user, who may have low transaction thresholds.

In FIG. 9C, after risk evaluation of the user profile/account is approved, user profile/accounts having a higher risk score or level are monitored with increased due diligence of the user profile/account and associated transactions, as represented by blocks 901c, 903c, 905c, 907c and 909c. As represented by blocks 911c, 913c and 915c, the transaction activity is applied to the machine learning models to build networks for behavior and scoring, which may be enhanced by data enrichers. At a certain risk score threshold, the transaction associated with the user profile/account will be interdicted, as represented by block 917c. This fraudulent transaction will be blocked, as represented by block 919c. Further, an alert will be generated for review with the alert being prioritized based on risk factors, as represented by block 921c. In addition, this fraudulent transaction may be investigated and reported to a regulatory body, as represented by blocks 923c and 925c.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

This disclosure describes, among other things, a system that is uniquely positioned to sit alongside a gaming platform and many digital channels to provide the online game industry and merchants an end-to-end monitoring and detection solution. This system tackles the compliance vulnerabilities facing the industry by utilizing a two-prong approach. First, establishing a record for each user as they open user profiles/accounts (e.g., merchant or gaming using ISO020022 formatting), collecting enough information to verify and risk score the potential user. By reviewing and aggregating different user attributes, user profiles/accounts can be flagged for closer supervision with high-risk users to ensure their accounts are being used appropriately. Combining this risk assessment into a transactional data model—this system uses user purchase and transaction history to establish expected behaviors. This system will provide a digital face of user's entity risk plus interaction within the game's economic market—regardless of fiat based virtual game currencies or closed loop in-game created currencies. Additionally, this system provides the ability to prevent theft of valuable gaming artifacts via user profile/account takeover that are frequently offered in secondary and tertiary black/grey markets worth $128B (cite FINCENRPT) in suspect gaming currency.

By this system running detection models against these user profiles/accounts will provide the basis for identifying anomalous activity that warrants further review or investigation. With a unique data model, open-platform flexibility for event orchestration and dedicated user interface (UI), this system offers industry leading risk mitigation and money laundering detection products. Protect the user community, profitability and more importantly brand reputation by preventing illicit funding for terrorism, narcotics activity, tax evasion and other crimes flowing through a virtual environment system or platform.

This system is well suited to the gaming, payment industry, service merchants, acquirers and more by: using a set of rules that will prevent or block potential fraudulent transactions; using deep-learning models in tandem with rules to identify early risk behaviors for proactive prevention methods; transforming data to create standardized set of attributes (e.g., ISO20022) and enriching via cross pollination for a more intelligent UI; combining verification of digital identity/footprint of users to enable mitigation actions of related transaction; and enabling operations departments to quickly address affected entities or accounts based on accurate, intelligent information.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method performed by a first network node of monitoring and detecting suspicious activity in a virtual environment, comprising:
sending, by the first network node, to a second network node that operates a virtual environment, an indication that user activity performed in the virtual environment that is associated with a certain user profile of a plurality of user profiles of the virtual environment is suspicious activity, with that user activity being enabled by a third network node, the suspicious activity being determined based on:
a relationship between the user activity performed in the virtual environment that is associated with the certain user profile and user activity performed in the virtual environment that is associated with another of the plurality of user profiles;
an attribute of the certain user profile; or
an attribute of the third network node.

2. The method of claim 1, further comprising:
determining a suspicious activity risk score or level based on a suspicious activity risk classification rule set and the attribute of the certain user profile.

3. The method of claim 2, wherein the risk classification rule set includes at least one of:
an indication of whether the user is associated with a certain watchlist;
an indication of whether the user is associated with a certain group; and
an indication of whether the user is associated with certain legal or law enforcement activity.

4. The method of claim 2, further comprising:
determining a suspicious activity detection rule set based on the risk score or level.

5. The method of claim 4, further comprising:
estimating, based on the detection rule set, the relationship between the user activity associated with the certain user profile and the user activity associated with the other user profile.

6. The method of claim 5, wherein said estimating includes regression analysis modeling, based on the detection rule set, the relationship between the user activity associated with the certain user profile and the user activity associated with the other user profile.

7. The method of claim 5, further comprising:
determining that the user activity associated with the certain user profile is suspicious activity based on the estimated relationship and the attribute associated with the third network node.

8. The method of claim 5, further comprising:
determining that the user activity associated with the certain user profile is suspicious activity based on the attribute of the third network node responsive to determining that the estimated relationship is outside a predetermined activity threshold.

9. The method of claim 1, further comprising:
receiving, by the first network node, from the second network node, the user activity associated with the certain user profile.

10. The method of claim 1, further comprising:
receiving, by the first network node, from the second network node, the attribute of the certain user profile or the attribute of the third network node.

11. The method of claim 1, wherein the attribute of the third network node includes at least one of an operating system (OS), screen pixelization, X/Y axis movement and Internet protocol (IP) address associated with the third network node.

12. The method of claim 1, wherein the attribute associated with the certain user profile includes at least one of an occupation, citizenship, and residency of the certain user.

13. The method of claim 1, wherein the detection rule set is associated with regulatory policies.

14. A first network node, comprising:
a processor and a memory, the memory containing instructions executable by the processor whereby the processor is configured to:
send, to a second network node that operates a virtual environment, an indication that user activity performed in the virtual environment that is associated with a certain user profile of a plurality of user profiles of the virtual environment is suspicious activity, with that user activity being enabled by a third network node, the suspicious activity being determined based on:
a relationship between the user activity performed in the virtual environment that is associated with the certain user profile and user activity performed in the virtual environment that is associated with another of the plurality of user profiles;
an attribute of the certain user profile; or
an attribute of the third network node.

15. The first network node of claim 14, wherein the processor is further configured to:
determine a suspicious activity risk score or level based on a suspicious activity risk classification rule set and the attribute of the certain user profile, wherein the risk classification rule set includes at least one of:
an indication of whether the user is associated with a certain watchlist;
an indication of whether the user is associated with a certain group; and
an indication of whether the user is associated with certain legal or law enforcement activity.

16. The first network node of claim 14, wherein the processor is further configured to:
receive, from the second network node, the attribute of the certain user profile or the attribute of the third network node.

17. A method performed by a second network node of monitoring and detecting suspicious activity in a virtual environment, comprising:
receiving, by the second network node that operates a virtual environment, from a first network node, an indication that user activity performed in the virtual environment that is associated with a certain user profile of a plurality of user profiles of the virtual environment is suspicious activity, with that user activity being enabled by a third network node, the suspicious activity being determined based on:
a relationship between the user activity performed in the virtual environment that is associated with the certain user profile and user activity performed in the virtual environment that is associated with another of the plurality of user profiles;
an attribute of the certain user profile; or
an attribute of the third network node.

18. The method of claim 1, further comprising:
obtaining the user activity performed in the virtual environment that is associated with the certain user profile; and
sending, by the second network node, to the first network node, the user activity associated with the certain user profile.

19. The method of claim 1, further comprising:
determining that the user activity performed in the virtual environment that is associated with the certain user profile is suspicious activity responsive to the receiving the indication; and
suppressing the user activity performed in the virtual environment that is associated with the certain user profile.

20. A second network node, comprising:
a processor and a memory, the memory containing instructions executable by the processor whereby the processor is configured to:
receive, by the second network node that operates a virtual environment, from a first network node, an indication that user activity performed in the virtual environment that is associated with a certain user profile of a plurality of user profiles of the virtual environment is suspicious activity, with that user activity being enabled by a third network node, the suspicious activity being determined based on:
a relationship between the user activity performed in the virtual environment that is associated with the certain user profile and user activity performed in the virtual environment that is associated with another of the plurality of user profiles;
an attribute of the certain user profile; or
an attribute of the third network node.
